(19) United States
(12) Patent Application Publication
(10) Pub. No.: US 2009/0094275 A1
(43) Pub. Date: Apr. 9, 2009

(54) AUDITABLE ACTION REQUEST PROCESSING IN A WORKFLOW ENVIRONMENT

(75) Inventors: Richard D. Patton, Hastings, MN (US); Michael Alexander Herrmann, St. Paul, MN (US); John Walter Sperle, Woodbury, MN (US); Jean Renee Grams, St. Paul, MN (US); Leon Curtis Johnson, Inver Grove Heights, MN (US); Gregory D. Lundgren, Lino Lakes, MN (US); Bradwin Eliot Preston, Apple Valley, MN (US)

Correspondence Address: SCHWEGMAN, LUNDBERG & WOESSNER, P.A., P.O. BOX 2938, MINNEAPOLIS, MN, 55402, US

(73) Assignee: Lawson Software, Inc., St. Paul, MN (US)

(21) Appl. No.: 11/869,584

(22) Filed: Oct. 9, 2007

(51) Int. Cl. G06F 7/00; G06F 9/44

(52) U.S. Cl. 707/103 R; 719/315; 707/E17.044

(57) ABSTRACT

Various embodiments provide one or more of systems, methods, software, and data structures that include action request definitions that may be linked to a workflow process. Upon submission of an action request from an action request definition, an action request record may be created as a function of an action request definition and passed through a linked workflow process. The action request record may be modified, approved, or rejected. If approved, a process defined within the action request definition may cause a data change as a function of action request data. Action request records may be persisted, in some embodiments, to provide an action request audit trail.

### BACKGROUND INFORMATION

Often organizations need to route work and information through multiple levels or approval or review, gathering data from multiple sources before taking some particular action within a separate system. Workflow systems arc commonly used for this routing of work and information. However, workflow systems often fail to provide flexibility desired by organizations when implementing workflows. These workflow solutions often do not integrate well with other systems. Further, the ability to track and audit workflow data is limited and disjointed outside of such a workflow system.

### BRIEF DESCRIPTION OF THE DRAWINGS

FIG. 1 is a block diagram of a system according to an example embodiment.

FIG. 2 is a block diagram of a system according to an example embodiment.

FIG. 3 is a block diagram of a system according to an example embodiment.

FIG. 4 is a block flow diagram of a method according to an example embodiment.

FIG. 5 is a block flow diagram of a method according to an example embodiment.

FIG. 6 is a block diagram of a computing device according to an example embodiment.

FIG. 7 is an illustration of a user interface according to an example embodiment.

FIG. 8 is an illustration of a user interface according to an example embodiment.

FIG. 9 is an illustration of a user interface according to an example embodiment.

FIG. 10 is an illustration of a user interface according to an example embodiment.

### DETAILED DESCRIPTION

As mentioned above, organizations often route work through multiple levels of approval, gathering data from multiples sources before taking some action on objects or data in a system. Sometimes, certain data may be required by a particular participant in the process, while sensitive or irrelevant data should not be visible to some participants, yet at the time the action is actually performed on the system, all data must be present and valid. Hiring, promoting or transferring an employee, or creating a new customer account are a few examples of such processes. Additionally, organizations may desire to create customized actions, such as an address change action, which may make use of existing underlying business rules, which may be applied through accessing services of one or more objects.

Various embodiments described herein provide one or more of systems, methods, software, and data structures that include a definition of an action request separate from a workflow definition. In some embodiments, an action request definition includes information to instantiate an action request record in an action request database, an association to a workflow process through which an instantiated action request record will be routed, and an instruction set, which when executed causes an update to data in one or more locations, such as objects or in a database, as a function of the action request record. In some embodiments, the action request record remains in the action request database as an auditable record of an action approval workflow process through which the action request record passed.

In some such embodiments, an action request provides an integrated mechanism that enables these capabilities on virtually any object or data item in a system. In some embodiments, an action request, as it flows through a workflow process, gathers data from each of one or more participants in the process and ultimately submits an the action request to the system when the workflow process is complete. Additionally, the action request may provide auditing of changes to an action request as it flows through the workflow process, and may provide an audit trail between the action request and the underlying objects and/or data changed during processing of the action request. These and other embodiments are described in detail below.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

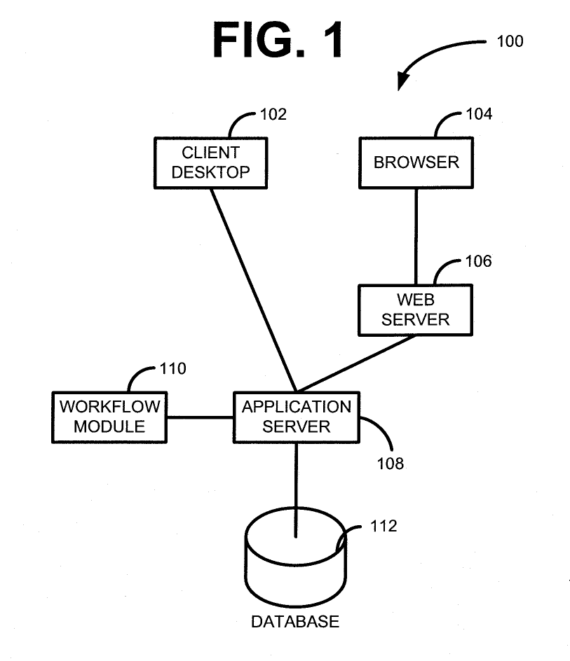

FIG. 1 is a block diagram of a system 100 according to an example embodiment. The system 100 includes clients, such as a client desktop application 102 a web browser 104 client communicatively coupled to the system 100 via a web server 106, or other client types. The clients communicate with an application server 108. The application server 108, in typical embodiments, includes objects that provide services. Such services may be called directly or indirectly by clients, such as the client desktop application 102 and the web browser 104 client, or by other objects. The services of the objects may provide access to or manipulate data stored in a database 112 or other data storage locations.

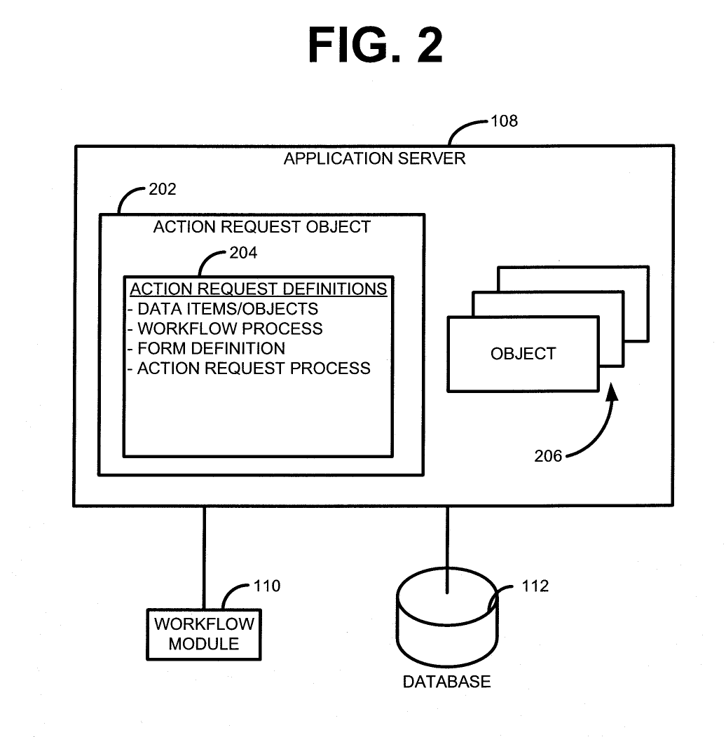

In some embodiments, the system 100 further includes a workflow module 110. The workflow module 110 may be a standalone workflow system or integrated within the application server 108. Further detail of the application server 108, according to an example embodiment, is illustrated and described with regard to FIG. 2.

FIG. 2 is a block diagram of a system according to an example embodiment. The system includes the application server 108, the database 112, and the workflow module 110. The application server 108, in one embodiment, includes one or more objects 206. One such object is an action request object 202. An action request object 202, in typical embodiments, includes action request definitions 204 and provides action request related services.

Action request definitions 204 may exist in, or be accessed by, the action request object 202 for each type of action request a user may submit. For example, an action request definition 204 may exist for employee vacation requests, customer service requests, a hire employee request, or other request, the fulfillment of which results in an action being performed against or with data in the database.

Action request definitions 204 typically identify data items, or object services providing data items, to include in an action request. An action request definition may also be associated with a workflow process defined in the workflow module 110. In some embodiments, a form definition may also be included in an action request definition. Action request definitions also include an action request process that is executable to instantiate an action request once approved.

In some embodiments, an action request definition 204 may also include an approval definition. An approval definition may specify a rule that maybe applied to determine if an action request is approved or denied. An example approval definition may include a rule specifying that a workflow process final node must receive an approval indication for an action request to be approved. However, a workflow process may not include a final node, instead including two or more approver nodes. In such an instance, the approval definition may specify that an action request be approved upon receipt of an approval indication from one approver node, two approver nodes, three approver nodes, all approver nodes, or another number, percentage, or other ratio of approver nodes. Further approver definitions in such instances where there is not a final approver node in a workflow process may classify an action request as denied if a certain number, percentage, or other ratio of approver node users deny the action request.

In other embodiments, an approval definition may be specified in a defined workflow process in the workflow module. In some such embodiments, the approval definition may be associated with a node in a workflow process. A node is typically a stopping point in a workflow process that waits to receive input from a user associated with the node. Such input may be an approval or denial of an action request, but may also be input to return the action request to a previous node or even an initiator for further information or other input. In some embodiments, upon receipt of such input, the node may include a rule to determine a workflow action to take based on the received input. Some such node rules may require or be capable of processing input received from one or more users associated with the node. Some such rules may require approval or denial by more than one user associated with the node before being triggered.

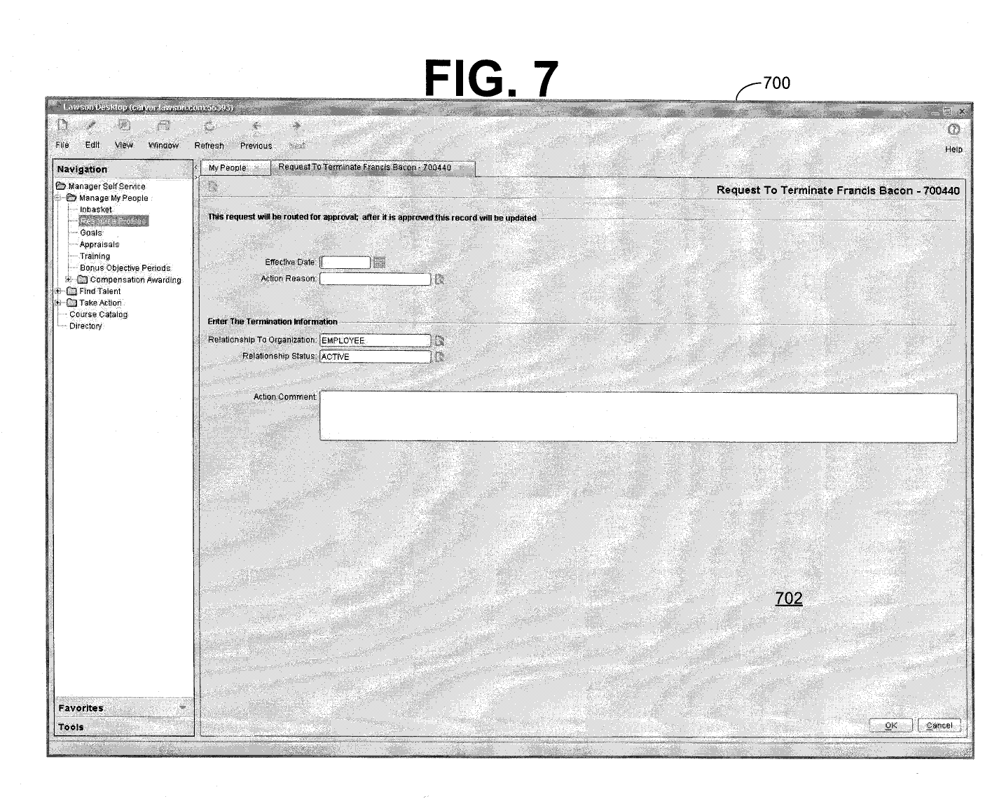

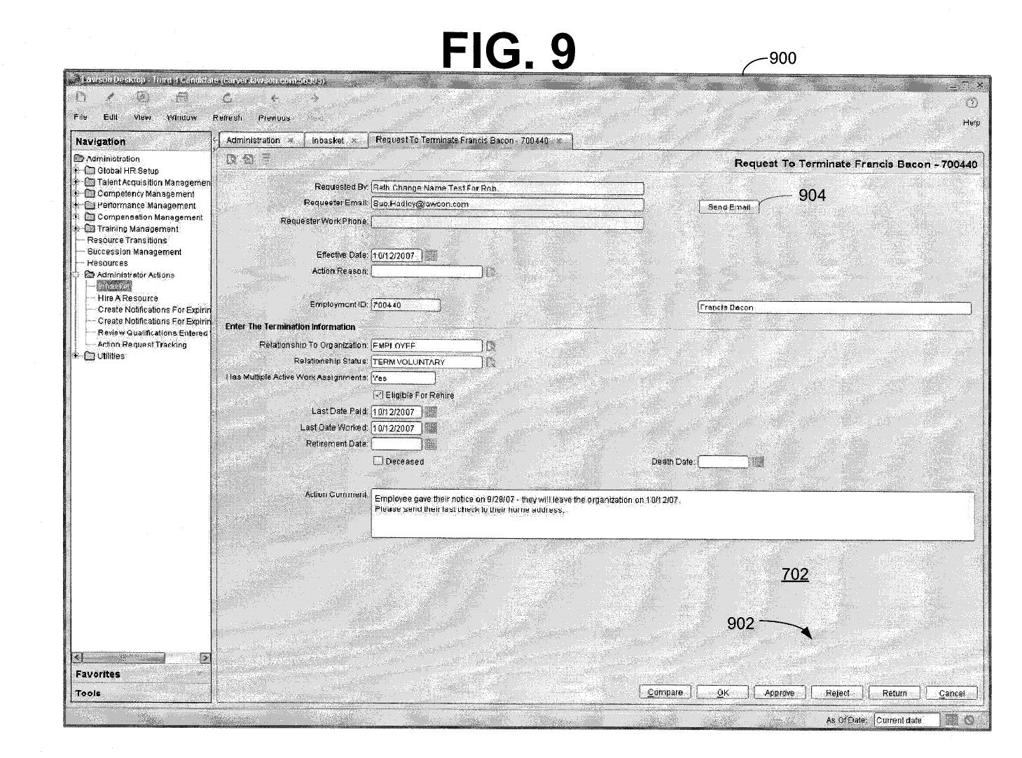

A form definition typically includes the identified data items. In some embodiments, a form may be displayed within a user interface as a function of a form definition to receive input from an action request initiator, approver, or final approver. The form when displayed in such embodiments provides a view of some or all of the data items of the action request definition. Examples of a displayed form are illustrated in FIG. 7 and FIG. 9, and described below. However, some data items, although present in the form, may not be visible. For example, if a particular action request needs certain information to identify data in an object, but that data has no meaning to a user, such data may be invisible. Sensitive data, such as social security numbers, pay rates, and other data may also be conditionally visible as a function of a role of a user viewing the form, such as an initiator, approver, or final approver in a workflow process associated with the action request definition. For example, a final approver may be a member of the accounting department of an organization and needs to see certain sensitive financial data included in an action request. However, that same data may be too sensitive, or otherwise confidential, to an approver who may be a non-accounting manager. The non-accounting manager, having a role of just approver, may be prevented from viewing some data items while the final approver is able to view such data items.

Similarly, if a data item is visible in a form, some or all users may be prevented from editing some data items. For example, a data item in an employee record, such as name or social security number, may not be edited by any users when an action request definition is with regard to a vacation request. However, a field in the vacation request specifying the dates of vacation requested may be editable by an initiator or an approver, who may be a the initiator's manager, but not editable by a final approver who may be a member of the human resources department.

A form definition may also include one or more actions a user may take with the form. For example, if the user is an approver, a form definition may specify that an approve button be displayed, the selection of which may cause an indication of approval by the approver to be stored in an action request database. Some embodiments may also include a deny button, the selection of which may cause an indication of denial by the approver to be stored in the action request database. However, in some embodiments, an indication of the approval is not stored in the action request database. Instead, an action maybe performed upon selection of one of the action buttons, such as storing the action request record, and communicate an indication of the selected action button to the workflow process, which may cause the action request record to be forwarded to a next node of the workflow process.

In some embodiments, an action request process of an action request definition 204 may call one or more object services to instantiate the action request upon final approval of the action request. For example, if an action request is a request to hire an employee, data of a candidate that is the subject of the hire employee request included in the hire employee action request may be instantiated in an employee table through action request process calls to an employee object.

In some embodiments, services provided by the action request object 202 include an action request initiation service, the execution of which typically causes an action request record to be instantiated in the database 112. The action request record may be instantiated according to an action request definition and may include data submitted in a form received from an action request initiator. The action request object may further include services that manipulate action request records in the database 112, such as create, read, update, and delete services. One such service may include a service, which when called, causes an action request process of an action request definition 204, as discussed above, to be executed.

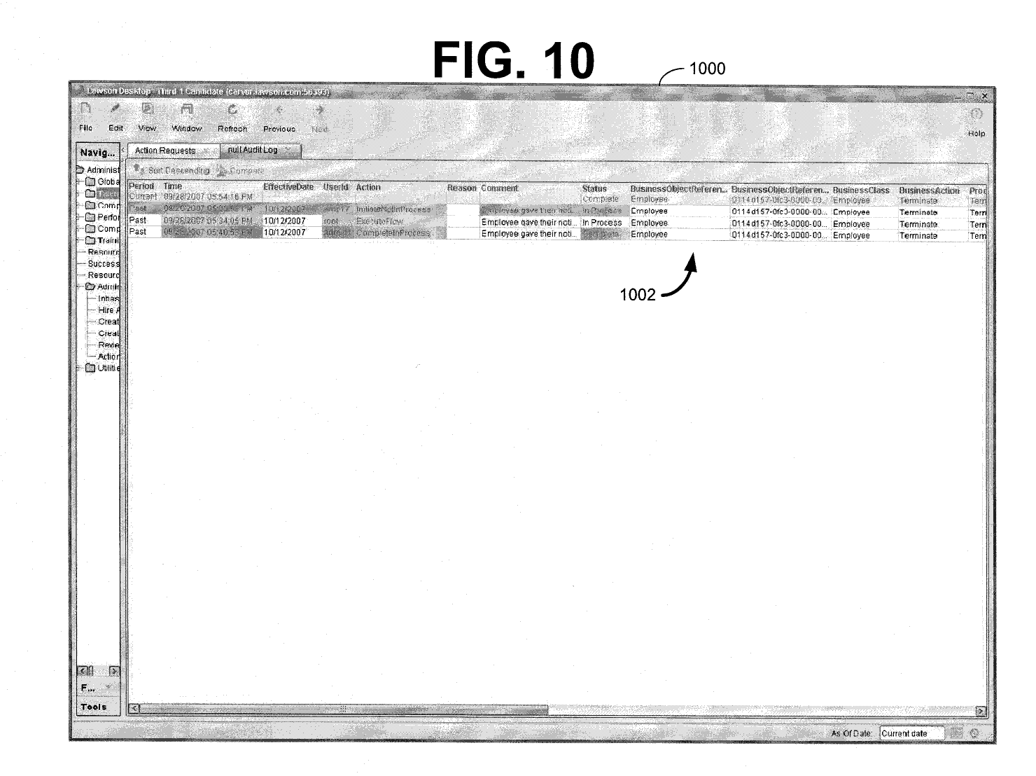

In some embodiments, one or more audit services may be provided by the action request object 202. Such audit services may allow a user to view an action request record in the database 112 to see how an action request was processed by users in a workflow process associated with an action request definition. An example of an action request audit view is illustrated in FIG. 10, which is described below. Such action request object 202 services are typically general services that may operate on any action request definition 204. Thus, an action request definition 204 may be added to the action request object 202, such as by storing an action request definition 204 in a repository of action request definitions 204 referenced by the action request object 202, to implement a new action request type.

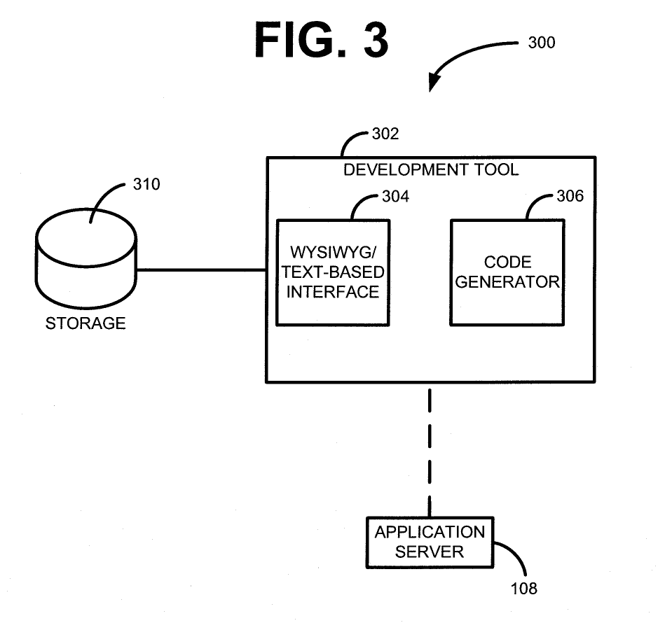

FIG. 3 is a block diagram of a system 300 according to an example embodiment. The system 300 is an example of a system that may be used to create action request definitions. The system 300 includes a development tool 302, storage 310, and the application server 108.

The development tool 302 includes a What-You-See-Is-What-You-Get (“WYSIWYG”)/text-based interface 304 which may be used to create action request definitions. An action request definition, once created, may be stored in storage 310. The storage 310 may be local to a computing device including the development tool 302 or on a networked storage device accessible to the computing device. The development tool 302 may also include a code generator 306 to generate executable code as a function of an action request definition created using the WYSIWYG/text-based interface 304. For example, the WYSIWYG/text-based interface 304 may be used to create an action request definition in a markup language. Input received in the WYSIWYG/text-based interface 304 may include one or both of graphical input and text-based input, such as in a markup language. Graphical input may be transformed by the WYSIWYG/text-based interface 304 into text which maybe viewed in a textual manner. Further, text-based input maybe transformed by the WYSIWYG/text-based interface 304 into a graphical view which may be viewed in a graphical manner. The code generator 306 may be used in some embodiments to generate executable code, such as Java code, to implement some or all of the action request definition. The code generator 306, in some embodiments, may also, or alternatively, be included in an object accessible over a network.

The development tool 302, in some embodiments, includes a representation of objects, services, and data available on an application server, such as application server 108 illustrated and described above with regard to FIG. 1 and FIG. 2. In other embodiments, the development tool 302 may communicate with an application server to access the objects, services, and data available thereon. The objects, services, and data may be selected in the WYSIWYG/text-based interface 304 for inclusion in an action request definition. The WYSIWYG/text-based interface 304 also typically includes a form definition interface to allow placement of selected data items as fields in a form and definition of properties associated with those fields. Some such properties may designate fields as visible or invisible. If a field is visible, it may be further designated as read-only. The visibility and read-only properties of a field may be made conditional based a role of a user when viewing the form. For example, a field may have a property making the field visible to all users, but editable only by an approver. Another field may be visible only to a final approver.

In some embodiments, the WYSIWYG/text-based interface 304 may further allow inclusion of action buttons, such as approve and denial buttons that are viewable and selectable only by a user having an approver role. In some other embodiments, certain buttons may automatically placed on a form, but the WYSIWYG/text-based interface 304 may be utilized to designate visible and invisible properties of such buttons based on roles of users at certain workflow process nodes. In some embodiments, a form may automatically include an OK action button which may be used to save changes made to a form and a cancel button to close the form without making any changes. In some such embodiments, the action buttons displayed in a form may be specified by properties of a workflow process node. In use, such buttons, when selected by a user, indicate whether the approver approves or denies an action request of the type of the action request definition. When an action button is selected in some embodiments, any modifications to the action request form may be saved to the action request record and an indication of the button selected may be forwarded to a next node of an associated workflow process advising the workflow process of the choice based on the approval or denial. The next node may be a next approver node or a final approver node. The node receiving the indication of the choice may then determine what to do next, such as triggering an action request process to complete the action request, wait for additional responses, or forward the action request record to a next node.

An action request definition, once created, may be published to the application server 108, such as to the action request object 202 of FIG. 2 described above. Once published, the action request definition may be available to some or all users to submit such an action request and have the action request flow through a workflow process toward approval or denial. When a user submits an action request, an action request record is typically instantiated in an action request table of a database. An action request record, in such embodiments, may be instantiated as a function of the action request definition of the action request type submitted. Such an action request record typically includes at least the data items included in the action request definition as selected using the development tool 302. An action request record may further include one or more of data identifying a location in an associated workflow process, an identifier of the associated workflow process, a date the action request was submitted, an identifier of an approved, denied, or pending status of the action request, and other data depending on the embodiment.

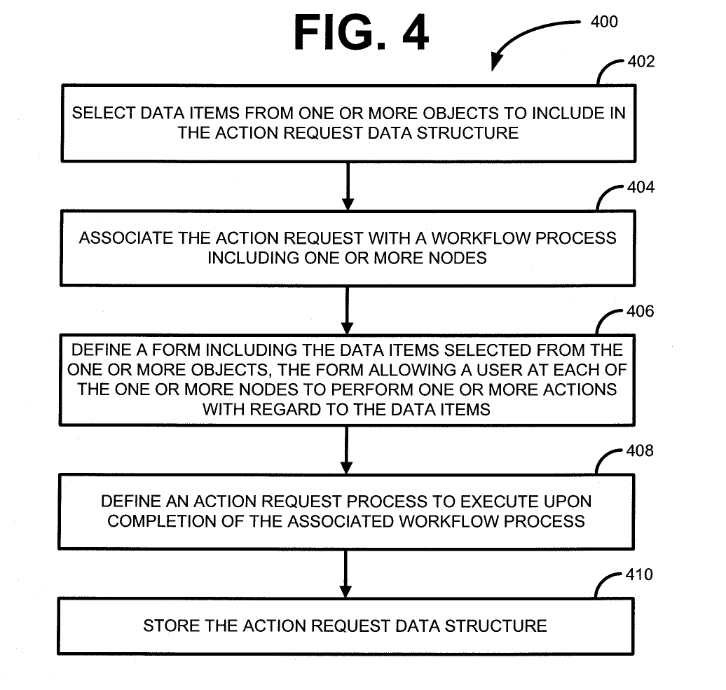

FIG. 4 is a block flow diagram of a method 400 according to an example embodiment. In some embodiments, the method 400 is a method that may be performed, at least in part, using the development tool 302 of FIG. 3 described above to define an action request data structure.

The method 400 may include selecting 402 data items from one or more objects to include in an action request data structure and associating 404 the action request with a workflow process including one or more nodes. The method 400 may also include defining 406 a form including the data items selected from the one or more objects. Such a form typically allows a user at each of the one or more nodes to perform one or more actions with regard to the data items. The method further includes defining 408 an action request process to execute upon completion of the associated workflow process. The action request data structure may then be stored 410. The stored 410 action request data structure typically includes a representation of the selected data items, an association to the workflow process, a representation of the form, and a code representation of the action request process.

In some embodiments, defining 406 the form includes designating one or more of the data items as visible in the form when displayed to a workflow node user. The designation of at least one data item as visible in the form may be a conditional designation determined as a function of a role of the workflow node user. In some such embodiments, one or more data items designated as visible in the form may be further designated as read-only. A read-only designation may be a conditional designation determined as a function of a role of the workflow node user.

In some embodiments, defining 408 the action request process may include identifying at least one service of one or more objects to be called upon completion of the associated workflow process and designation one or more of the data items included in the form to be submitted with the calling of the at least one service. However, other embodiments may include updating data items in a database directly without the use of object services.

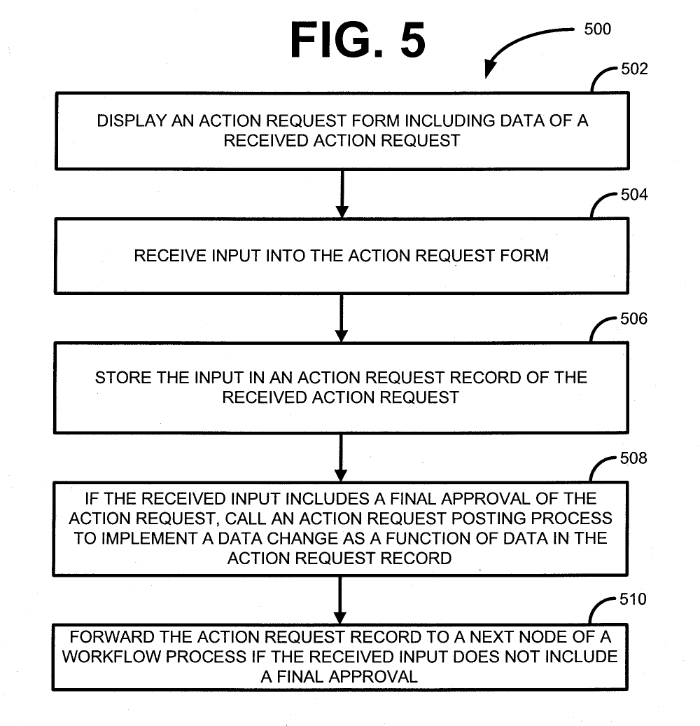

FIG. 5 is a block flow diagram of a method 500 according to an example embodiment. The method 500 is an example of how an action request may be processed at a workflow process node. The method 500 may include displaying 502 an action request form including data of a received action request and receiving 504 input into the action request form. The method 500 may then store 506 the input in an action request record of the received action request. If the received input includes a final approval of the action request, the method 500 may include calling 508 an action request posting process to implement a data change as a function of data in the action request record. However, if the received input does not include a final approval, the method 500 may include forwarding 510 the action request record to a next node of a workflow process or remaining at a current node of a workflow process if an approval or denial rule has not yet been satisfied. In some embodiments, an action request may be returned to a previous node. In other embodiments, the calling 508 of the action request posting process, forwarding 510 of the action request record, returning the action request record to a previous node, or other action may be identified and performed by the workflow process. In some embodiments, the action request form is associated with an action request definition of a type of the received action request.

In some embodiments, an action request record may also include a status. A status may be “not in process,” “in process,” “rejected,” “complete,” or other status. The status may be set when an action request record is created, such as by setting the status to “in progress.” When an action request record is approved, the status may be set to “complete” and if denied, set to “rejected.” The “not in process” status may be set if a an action request is not addressed within a certain time period, if the action request is saved but not submitted by an initiator, or in other situations. A status may be used by workflow processes to identify action request records in need of routing. The status may also be used to designate an action request record as available for an auditing view or other purpose. That status may be set automatically such as by a workflow process or other process. In some embodiments, the status may also, or alternatively, be set manually, such as through a manual data change, calling an object service, or using an action request form.

The action request record may be created as a function of an action request definition of a type of the received action request. The action request posting process called 508 in the method 500 typically implements the data change by modifying one or more data values in a production dataset as a function of data in the action request record.

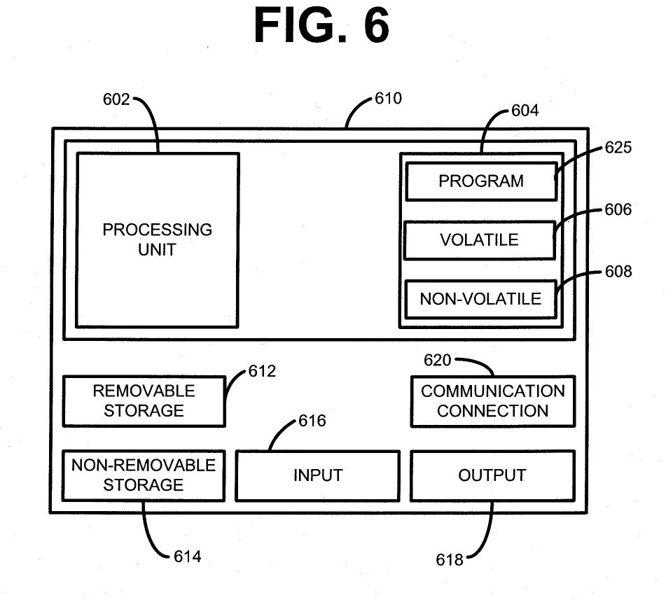

FIG. 6 is a block diagram of a computing device according to an example embodiment. In one embodiment, multiple such computer devices may be utilized in a distributed network to implement multiple components in a transaction-based environment, such as the environment of the system 100 illustrated and described with regard to FIG. 1. An object-oriented, service-oriented, or other architecture may be used to implement such functions and communicate between the multiple computing devices, systems, and components. One example computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer 610 may operate in a networked environment using a communication connection to connect to one or more remote computers, such as database and application servers. The remote computer may include a personal computer (PC), server, router, network PC, a peer device or other common network node, or the like. The communication connection may include one or more of a Local Area Network (“LAN”), a Wide Area Network (“WAN”), the Internet, or other networks.

Computer-readable instructions stored on a computer-readable medium are executable by the processing unit 602 of the computer 610. A hard drive, CD-ROM, and RAM are some examples of articles including a computer-readable medium. For example, a computer program 625 implementing one or more of the method described herein may be stored on a computer-readable medium. The computer program, in some embodiments, may be the client desktop application 102 or the web browser 104 as illustrated and described with reference to FIG. 1 depending on the particular embodiment.

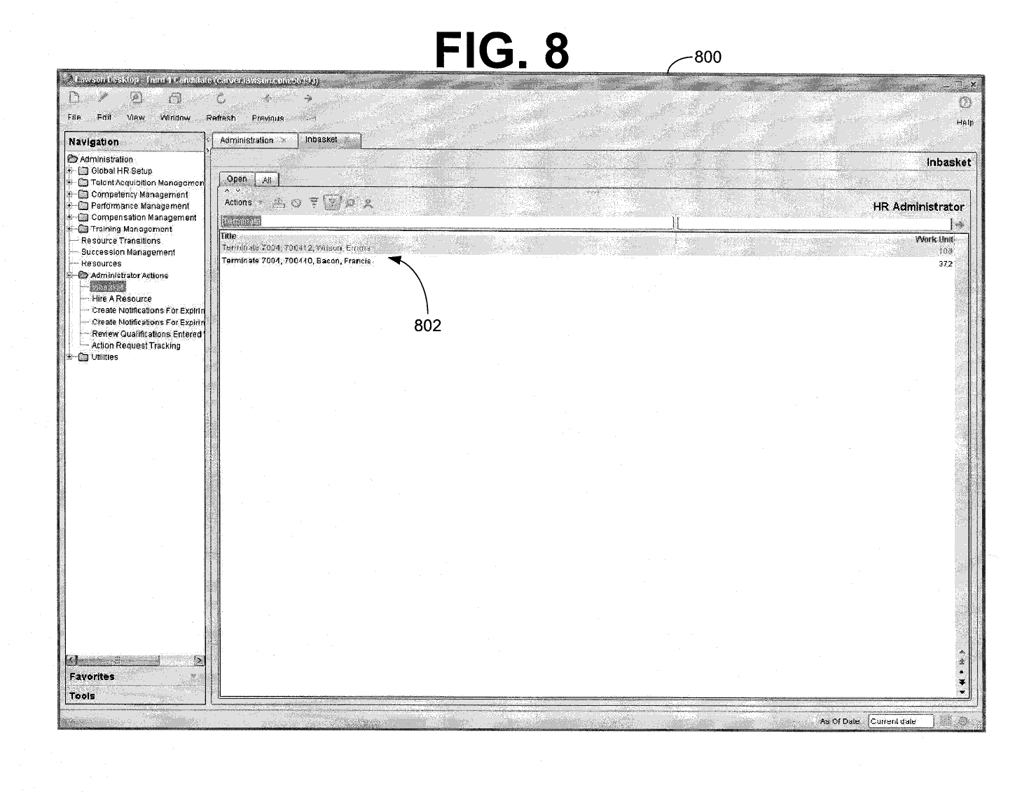

The client desktop application 102 and the web browser 104 are typically operable in various embodiments to present user interfaces to users. Such user interfaces may allow a creation and submission of an action request, provide a view of an action request inbox, provide a view of a pending action request and receive further input, provide an auditing view of action requests, and other user interface. Examples of some such user interfaces are illustrated in FIG. 7, FIG. 8, FIG. 9, and FIG. 10.

FIG. 7 is an illustration of a user interface 700 according to an example embodiment. The user interface 700 allows a user to initiate an action request by completing an action request form 702. The action request form 702 includes several data items that may be filled in by the user. Some such fields may be filled for the user when the form 702 is opened within the user interface. Some such fields may not be editable by the user. Further forms may also exist in the form 702, but not displayed. The form 702 is an example of a form that may be defined in an action request definition 204 stored in, or by, the action request object 202 as illustrated and described with regard to FIG. 2. The form 702 may be created using the development tool 302 as illustrated and described with regard to FIG. 3. Once an action request initiator completes the form 702, the form 702 may be submitted by selecting the “OK” action button at the bottom of the form 702.

Upon submission of the form 702, an action request record may be created in an action request table of a database. Once the action request record is created, a message may be sent by the system to a workflow process identified in an action request definition of the type of action request of the form 702. The workflow process will forward the action request record to a workflow inbox of a first node of the identified workflow process.

FIG. 8 is an illustration of a user interface 800 according to an example embodiment. The user interface 800 is an example of a workflow inbox view of a user. The user interface 800 displays a list 802 of workflow items, such as action requests, awaiting action from the user. The user may select one of the listed 802 workflow items to view further detail and to perform the action. Such a selection may cause another user interface to open, such as user interface 900 of FIG. 9.

FIG. 9 is an illustration of a user interface 900 according to an example embodiment. The user interface 900 includes a further illustration of the form 702 described above with reference to FIG. 7. The form 702 as illustrated in the user interface 900 is provided to a user in the workflow process that is in a role of approver. Note that the form 702 as displayed in the user interface 900 to an approver includes data items not displayed when the form 702 is displayed in the user interface 700 to the action request initiator. This is an example of how certain data items or fields may be visible or invisible based on a role of the user. Further note that the action buttons 902 of the form 702 as displayed in the user interface 900 do not match the action buttons in the user interface 700. This is an example of how various controls may be visible or invisible based on a role of the user viewing the form 702 as described above with regard to action request form definitions.

In the user interface 900, various form 702 fields may be edited, comments may be added, and messages may be sent, such as through the send email action button 904. The approve action button of the group of action buttons 902 may be selected to approve the action request.

If the current user is not a final approver, the action request record will be routed by the workflow system to a next node and placed in the workflow inbox of a user associated with that node. However, if the current user is the final approver, or an approver providing an approval that meets an approval rule of the action request definition, the action request will be processed according to the action request process associated of the action request definition of the current action request to instantiate the action request. For example, if the action request is a request to terminate an employee, an employee record may be modified as a function of the approved action request record. This may be cause deletion of an employee record, insertion of a record to a terminated employee table, updating a termination date of an employee record, or calling of an object service to perform the data update.

In some embodiments, the action request record may then be deleted. However, in other embodiments, the action record may persist to allow an audit view of the action request processing. Such a view may provide insight as to why or how an action was taken or certain data was updated. In many computing environments, audit trails are maintained that provide a record of how certain data fields change over time and may provide a date a change was made and identity information of a user making the change. However, there is no further information that may provide insight as to the process or decision making that went into making a data change. In various embodiments described herein, persisted action requests may provide additional information. For example, if an action request is a request to promote an employee and that request is denied, the action request record may include information on who denied the request and why. This information may be useful for other purposes. Many other scenarios where this level of audit detail may be useful exist and will be readily apparent to the reader. An example user interface 1000 of how such audit data of an action request may be presented is illustrated in FIG. 10.

FIG. 10 is an illustration of a user interface 1000 according to an example embodiment. The user interface 1000 is an audit view of action request records 1002 according to an example embodiment. In some embodiments, an action request record may be selected and displayed in another user interface, such as in a user interface to display some or all of the action request record data in a form of the action request definition of the selected action request record.

Some further embodiments provide a system including at least one object having one or more of data items and services accessible by one or more of system processes and other objects. Such a system may also include an action request module operable to hold action request definitions. The action request definitions may include at least one object having one or more of data items and services accessible by one or more of system processes and other objects. The system may also include an action request module operable to hold action request definitions. An action request definition may include an association to one or more data items from the at least one object, an association to a workflow process defined in a workflow module, an association to a form including the associated data items of the at least one object, and an action request process, which when executed, causes a data change included in an action request record of an action request database to be instantiated in at least one object. The action request database in such embodiments is typically operable to store action request records instantiated as a function of an action request definition. The workflow module may operate to receive and route an action request record to one or more nodes of a workflow process associated with an action request definition of the action request record and, upon final approval of an action request, trigger processing of an action request record according to an action request process included in an action request definition.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method of defining an action request data structure comprising:
selecting data items from one or more objects to include in the action request data structure;
associating the action request with a workflow process including one or more nodes;
defining a form including the data items selected from the one or more objects, the form allowing a user at each of the one or more nodes to perform one or more actions with regard to the data items;
defining an action request process to execute upon completion of the associated workflow process; and
storing the action request data structure includes a representation of the selected data items, an association to the workflow process, a representation of the form, and a code representation of the action request process.

2. The method of claim 1, wherein defining the form includes designating one or more of the data items as visible in the form when displayed to a workflow node user.

3. The method of claim 2, wherein the designation of the at least one data item as visible in the form is a conditional designation determined as a function of a role of the workflow node user.

4. The method of claim 2, wherein at least one data item designated as visible in the form is further designated as read-only.

5. The method of claim 4, wherein the designation of at least one data item as read-only is a designation determined as a function of a role of the workflow node user.

6. The method of claim 1, wherein defining the action request process includes:
identifying at least one service of one or more objects to be called upon completion of the associated workflow process; and
designation one or more of the data items included in the form to be submitted with the calling of the at least one service.

7. A system comprising:
at least one object including one or more of data items and services accessible by one or more of system processes and other objects;
an action request module operable to hold action request definitions, an action request definition including:
an association to one or more data items from the at least one object;
an association to a workflow process defined in a workflow module;
an association to a form including the associated data items of the at least one object; and
an action request process, which when executed, causes a data change included in an action request record of an action request database to be instantiated in at least one object;
the action request database operable to store action request records instantiated as a function of an action request definition; and
the workflow module operable to:
receive and route an action request record to one or more nodes of a workflow process associated with an action request definition of the action request record; and
upon final approval of an action request, trigger processing of an action request record according to an action request process included in an action request definition.

8. The system of claim 7, wherein the workflow module routes an action request upon receipt from an action request initiator or upon approval by a non-final approver.

9. The system of claim 7, wherein the action request process of an action request definition includes a call to at least one service of an object to instantiate the data change in the at least one object.

10. The system of claim 7, wherein the data change instantiated by the action request process includes calling an object process to create a new data record.

11. The system of claim 7, wherein at least one data item of a form associated to an action request definition is designated as visible when displayed to a workflow node user.

12. The system of claim 11, wherein the designation of the at least one data item as visible in the form associated to the action request definition is a conditional designation determined as a function of a role of the workflow node user.

13. The system of claim 11, wherein at least one data item designated as visible in the form associated to the action request definition is further designated as read-only.

14. The system of claim 13, wherein the designation of at least one data item as read-only is a conditional designation determined as a function of a role of the workflow node user.

15. The system of claim 7, wherein an action request record, after processing by an action request process, is maintained in the action request database and is accessible as an audit trail of the associated workflow process.

16. The system of claim 7, further comprising:
a user interface operable to:
display forms of action request definitions, the forms when displayed including data of an action request record;
receive input into a displayed form, the input including a indication of approval or denial of an action request of the action request record; and
store data back to the action request record.

17. A computer-readable medium, with instructions thereon, which when processed cause a computer to:
display an action request form including data of a received action request;
receive input into the action request form;
store the input in an action request record of the received action request;
if the received input includes a final approval of the action request, call an action request posting process to implement a data change as a function of data in the action request record; and
forward the action request record to a next node of a workflow process if the received input does not include a final approval.

18. The computer-readable medium of claim 17, wherein the action request form is associated with an action request definition of a type of the received action request.

19. The computer-readable medium of claim 17, wherein the action request record is created as a function of an action request definition of a type of the received action request.

20. The computer-readable medium of claim 17, wherein the action request posting process implements the data change by modifying one or more data values in a production dataset as a function of data in the action request record.
